(19) United States
(12) Patent Application Publication
(10) Pub. No.: US 2002/0071630 A1
(43) Pub. Date: Jun. 13, 2002

(54) Mechanism and method for fixing optical element

(76) Inventors: Yeh-I Su, Hsinchu (TW); Wei-Jen Chou, Hsinchu (TW); Chieh Hu, Taichung (TW); Hsin-Chieh Chiang, Taichung (TW)

Correspondence Address: BIRCH STEWART KOLASCH & BIRCH, PO BOX 747, FALLS CHURCH, VA, 22040-0747, US

(21) Appl. No.: 09/915,290

(22) Filed: Jul. 27, 2001

(30) Foreign Application Priority Data
Oct. 19, 2000 (TW) 89121916

(51) Int. Cl. G02B 6/293; G02B 6/36; G02B 6/38

(52) U.S. Cl. 385/24; 385/58; 385/73; 385/76

(57) ABSTRACT

A mechanism for fixing optical element that is applied to construct the optical element in an wavelength division multiplexer (WDM), or an dense wavelength division multiplexer (DWDM), the mechanism comprising a filter letting a beam of light with targeted wavelength pass through and in the meantime reflect the other beams of light (it is same on the other hand) and a holder being deployed in an optical pate of the WDM, which is tubular with a hollow part and having an incident end and an emitting end, and further there is a carry surface to let the filter be pasted on.

### BACKGROUND OF THE INVENTION

1. Field of Invention

The present invention relates to a mechanism for fixing optical elements and the method for doing the same and, in particular, to a mechanism that is applied in a wavelength division multiplexer (WDM) or a dense wavelength division multiplexer (DWDM) in order to fix a filter and the method for doing the same.

2. Related Art

E-Tek Dynamics Inc. Company disclosed several U.S. patents with regard to a kind of wavelength division multiplexers (WDMs) in years from 1996 to 2000, for example, U.S. Pat. Nos. 5,555,330, 5,652,814, 5,889,904 and 6,023,542. The wavelength division multiplexer (WDM) described in above patents is composed of a first collimator, a second collimator and a filter. Both collimators are constructed of a ferrule, a GRIN lens and a housing, wherein the first collimator has two optical fibers placed inside the ferrule in an adjacent manner, while the second collimator has one optical fiber inside the ferrule. The filter exhibits characteristic of transmitting targeted wavelength to the second collimator, and the rest wavelengths of incident light were reflected to the adjacent fiber of the first collimator, respectively.

The methods described in the above patents to put the filter and the two collimators together are widely introduced into industries. The filter is pasted directly by epoxy on the surface of the GRIN lens of the first collimator. When multi-wavelength light is incident from one of the fibers within the first collimator, the filter makes the reflected wavelengths being reflected to the other optical fiber of the first collimator. The two collimators were inserted into the metal sleeves individually, and they were placed to the mechanism body through the process of soldering/welding and packaging to consolidate the alignment. If there happen to be some problems during the process, it is difficult to recycle the filter since it has been pasted on the collimator surface. Since the filter's price is very expensive, it quite consumes a lot of cost.

In addition, Oplink Communications Inc. Company brought up an U.S. Pat. No. 5,946,435 that disclosed a three port WDM housing mechanism, each port has a collimator including one optical fiber. The filter is separated from the collimators and pasted into a cylindrical-shaped holder. Incident light beam emitted from the first collimator arrives to the filter, the direction of the filter is adjusted by rotating the holder, so that a targeted wavelength of the light beam passes to the second collimator, and the other wavelengths of the light beam were reflected to the third collimator. But the direction of reflective light beam changes depending on the rotation angle of filter holder. It makes the package process not easy to be control precisely. Furthermore, because the mechanism includes three different collimators, the size of WDM becomes larger. It does not fit in with technical trend.

### SUMMARY OF THE INVENTION

In view of the foregoing, it is an object of the present invention to design a structure of WDM that filters in bad WDMs are able to be recycled to save huge cost of filters.

It is another object of the present invention to design a structure of WDM which size is small and is able to be packaged easier.

In accordance with the above objects, the present invention provides a mechanism for fixing optical elements rigidly. First, a tubular metal holder with a hollow part is provided and there are a stop surface and a carry surface in order between the incident end and the emission end of the holder. Both of the above surfaces are located on different depths in the hollow part and the section view appears like a stair, the front view looks like two holes with same center but different radius. The next step is pasting the filter on the inner carry surface of the metal holder by epoxy, and then inserts the holder in the middle hollow position of the mechanism body of WDM, Two collimators like E-Tek method mentioned above, the incident light beam emitted from one fiber of the first collimator, the targeted wavelength determined by filter arrives to the second collimator, and the rest wavelengths of incident light beam are reflected back to the second fiber of the first collimator. The filter was isolated out of the two collimators, it exhibits strongly rigid strength with impacts, and it is easier to recycle the filter if the processes of producing get problems so as to reduce large cost. Moreover, the size of whole WDM's structure is small and the way of being assembled is easier, so that the present invention is competent for mass production.

Furthermore, there is a cave portion in front of the holder, which size is larger than the external diameter of the first/input collimator. It is convenient for the first collimator getting into or coming out the holder so as to be able to control the gap accurately between the first collimator and the filter. Moreover, for fitting the emission characteristic of slight inclined angle of the collimator, the present invention lets the holder within the mechanism body rotate a tilt angle of 0.6 degrees or designs a tilt carry surface around 0.6 degrees for pasting the filter with respect to normal incident plane.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limitative of the present invention, and wherein:

FIG. 1 shows a side section view of an embodiment of the present invention.

FIG. 2A shows an overlooked view of a first embodiment of the holder.

FIG. 2B shows an overlooked view of a second embodiment of the holder.

FIG. 3 shows a schematic view of constructing the holder into the mechanism body.

FIG. 4 shows a schematic view of further constructing the first collimator into the mechanism body in FIG. 3.

FIG. 5 shows a schematic view of further constructing the second collimator into the mechanism body in FIG. 3.

FIG. 6 shows a side section view of a third embodiment of the holder wherein the filter has been constructed in.

### DETAILED DESCRIPTION OF THE INVENTION

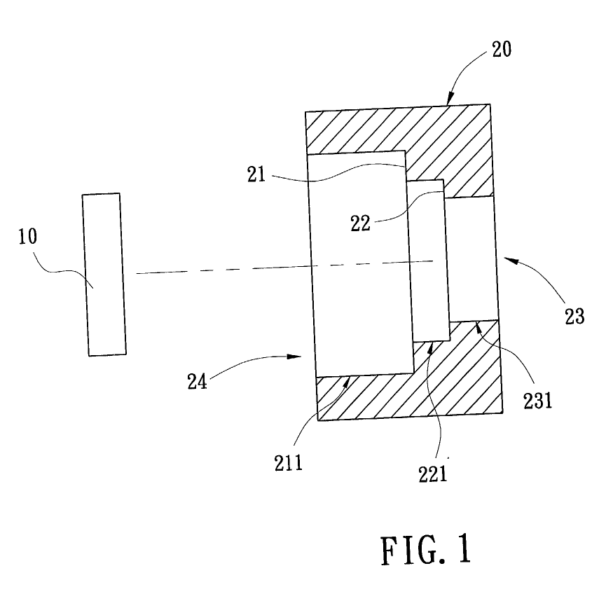

The present invention is applied in a wavelength division multiplexer (WDM) or a dense wavelength division multiplexer (DWDM) which is cascaded of a string of WDMs. With reference to FIG. 1, for solving the problem of recycling the filter 10 from a bad product, the present invention does not paste the filter 10 on the grin lens surface of the first collimator surface, the filter is pasted to the special metal holder 20 with epoxy, the holder is fixed into the middle hole of the WDM mechanism body by epoxy also. The major characteristic of the holder 20 is its three tubular holes 211, 221 and 231 within hollow part. The hollow of the holder 20 is in an optical path of the WDM so that light beam can pass through the incident end 24 and the emission end 23. There is a carry surface 22 in the hollow part of holder 20, which offer certain area for the pasting the filter 10. The size of the filter 10 decides the bore of holes 221 and 231 so as to be able to paste the filter 10 on the carry surface 22. The largest hole 211 lets the first collimator enter into the hollow portion of the holder 20 and control the gap between the first collimator and the filter easily.

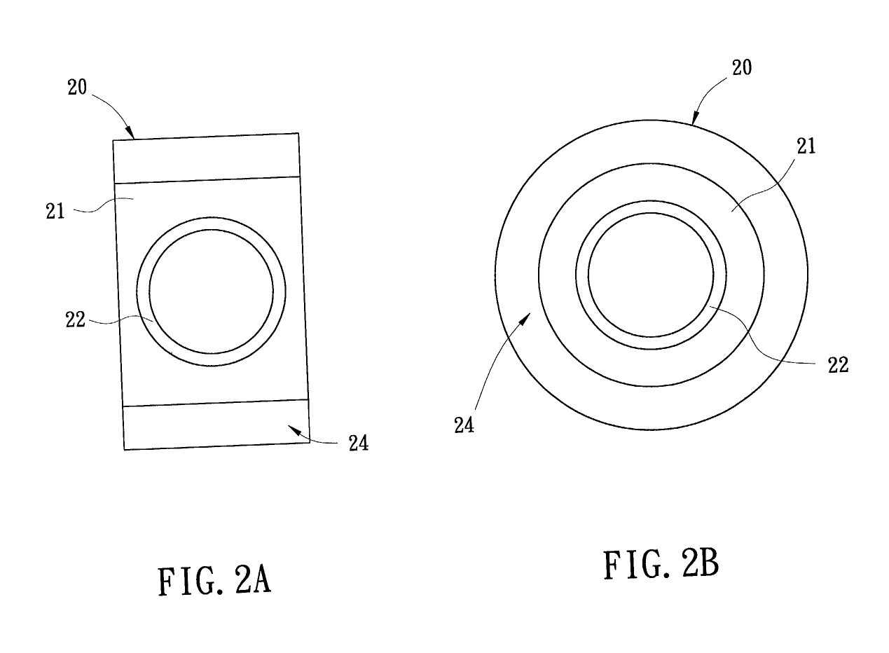

Regarding the appearance of the holder 20 is unlimited. It is all right to be made like a cuboid or a cube, as the first embodiment showing in FIG. 2A, or to turn into a cylinder, as the second embodiment showing in FIG. 2B. It depends on the mechanism body shape of the WDM, which the holder 20 fit snugly into the opening hole. Furthermore, although the filter 10 is usually made like a square, for the convenience of processing, the carry surface 22 is usually made like a circle.

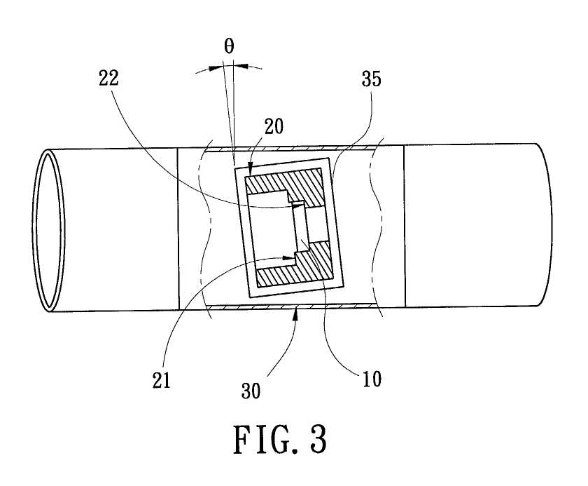

While making the WDM under the present invention's structure, referenced to FIG. 3, first, put the holder 20 into a containing space 35 in the Au coated mechanism body 30, which the filter 10 has pasted in the holder 20. Similarly, the appearance of the mechanism body 30 is unlimited. It is all right to be made like a cuboid, a cube, or a cylinder. Both of the size and shape of the containing space 35 has to snugly suit the size and shape of the holder 20. In addition, for the reason that the emitting light of the first collimator has a tilt angle of around 0.6 degrees to its axis, so the holder 20 also has to tilt 0.6 degrees to the mechanism body 30. In other words, the containing space 35 also is arranged to have a mechanism of fixed tilt angle of 0.6 degrees to the mechanism body 30, then the holder and mechanism body are attached rigidly by epoxy.

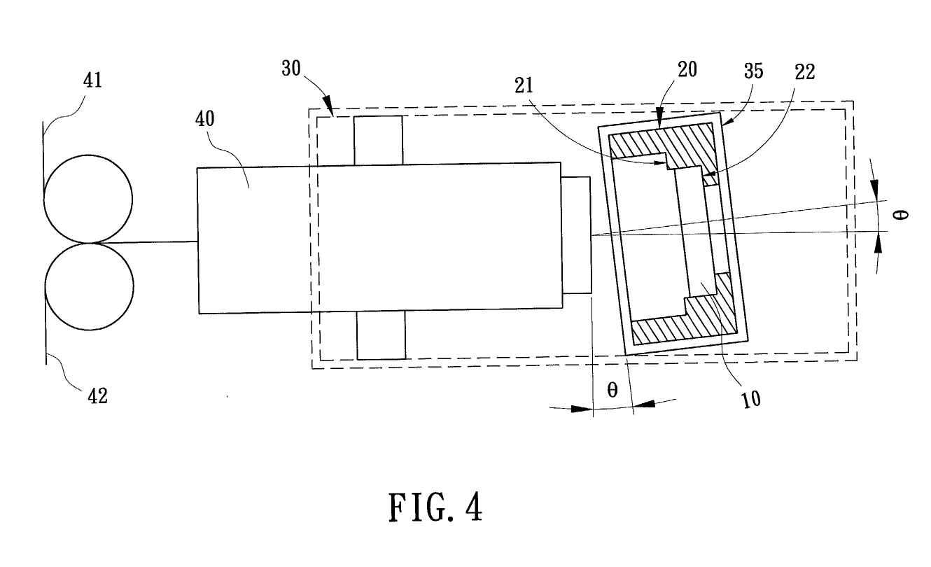

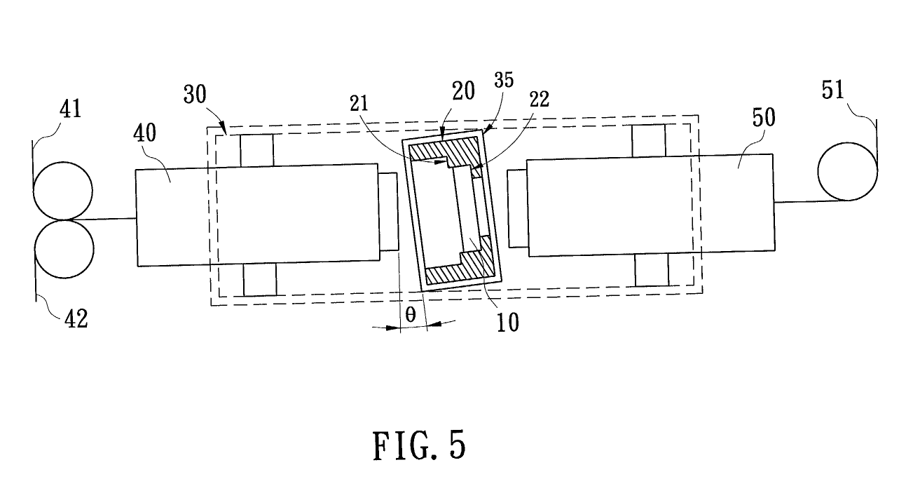

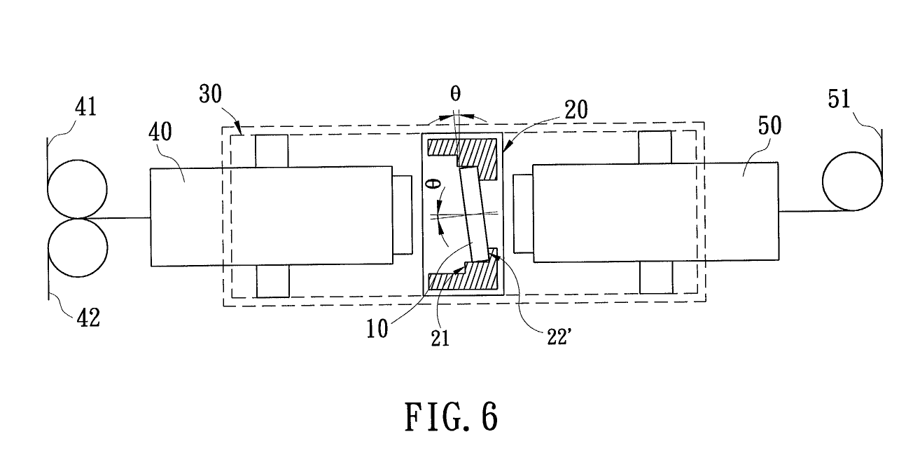

With reference to FIG. 4, after finishing above procedure, the next step is putting the first collimator 40 to a proper position inside mechanism body 30. It must be mentioned that the first and second collimators 40, 50 are inserted into Au coated metal tube and fixed by epoxy in advance. Arrange the first collimator 40 near the filter top surface of the holder 20, the multi-wavelength of the incident light emitted from fiber 41 reaches the filter 10, the targeted wavelength determined by the filter 10 passes to the second collimator 50 and in the meantime the reflected light beams goes back to the reflective fiber 42. Before fixing the first collimator 40, it is necessary to adjust the relative position/gap of the first collimator 40 and the filter 10 to get a maximum reflection light power. When the proper position is convinced, the next step is to fix the first collimator 40 within the mechanism body 30 by soldering or welding technology. With reference to FIG. 5, putting a second collimator 50 to the other side in the mechanism body 30, as the second collimator 50 received the maximum light power of targeted wavelength, the second collimator 50 is soldered/welded in the mechanism body 30 rigidly. With reference to FIG. 6, in order to match the inclination angle of 0.6 degrees of the emission beam of the collimator, the present invention further provide a third embodiment. The carry surface 22′ of the holder 20 is machined a inclined angle θ of 0.6 degrees related to the normal hollow axis of the carry surface 22′ of the holder 20 (paralleling the horizontal). So that the pasted filter 10 is inclined a tilt angle of 0.6 degrees directly on the carry surface 22′. Therefore, it is not necessary to tilt the holder 20, in other words, it is not necessary to make the containing space 35 inclined.

Thereinafter, there is a table 1 for comparing the differences among the present invention, the WDM's structure disclosed by E-Tek Dynamics Inc. Company and the same disclosed by OPLINK Communications Inc. Company:

TABLE 1

| | The present | | |
|---|---|---|---|
| Comparing items | invention | OPLINK | E-Tek |
| Number of collimator | 2 | 3 | 2 |
| Number of port | 2 | 3 | 2 |
| Adjusting the angle of filter | easy | easy | not easy |
| The angle between incident | small | large | small |
| light and reflective light | | | |
| Size of mechanism | small | large | small |
| Procedure for fixing the filter | easy | easy | not easy |
| Recycling the filter | easy | easy | not easy |

From above table, it is obvious that the WDM disclosed in the present invention not only has the advantages of small size, but also low cost and easy construction. The most specific point is easy to recycle the filter 10 so as to reduce large extra cost from erroneous processes of production.

With regard to the effects of the present invention are described as following:

1. Comparing with E-Tek Dynamics Inc. Company (U.S. Pat. Nos. 5,555,330, 5,652,814, 5,889,904 and 6,023,542)

The present invention is designed to aim at the mechanisms of WDM and DWDM. The filter is installed separately from the two collimators. If the processes of production get any problem, the filter is able to be recycled for many times. But the structure disclosed by E-Tek Dynamics Inc. Company, the filter is pasted on the surface of GRIN lens of first collimator (one of detailed description in U.S. Pat. No. 5,642,448, so it is not easy to recycle the filter. It is a big influence about the cost of product.

2.Comparing with OPLINK Communications Inc. Company (U.S. Pat. No. 5,946,453)

The structure of WDM disclosed by OPLINK Communications Inc. Company needs three collimators to be assembled together. Because the reflective end is isolated out of the incident end, it exhibits big size and high cost. It is not easy to rotate the filter holder to accommodate the correct targeted wavelength and reflection direction due to targeted wavelength will change with different incident angle, so it will influence the soldering/welding process. Oppositely, the structure of the present invention is simple. It only needs two collimators to assemble a WDM, so it is low cost and easily construction process. It does not to rotate the filter holder due to precisely machine-made inclination.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A mechanism for fixing optical element that is applied to construct the optical element in an wavelength division multiplexer (WDM) or an dense wavelength division multiplexer (DWDM), the mechanism comprising:
a filter letting a beam of light with targeted wavelength pass through and in the meantime reflect the other beams of light (it is same on the other hand); and
a holder being deployed in an optical path of the WDM, which is tubular with a hollow part and having an incident end and an emitting end, and further there is a carry surface to let the filter be pasted on.

2. The mechanism according to claim 1, wherein the incident end of the holder faces to the first collimator when the holder is fixed in the WDM or the DWDM.

3. The mechanism according to claim 2, wherein the incident end has a big hollow portion to let the first collimator be gotten into and come out.

4. The mechanism according to claim 1, wherein the appearance of the holder is a cuboid or a cube, and the shape of the carry surface is a circle.

5. The mechanism according to claim 1, wherein the appearance of the holder is a cylinder and the shape of the carry surface.

6. The mechanism according to claim 1, wherein the axis of the holder has a tilt of 0.6 degrees to the axis of the mechanism body of the WDM or the DWDM while the holder is fixed in the WDM or the DWDM.

7. The mechanism according to claim 1, wherein the normal of the carry surface has a tilt of 0.6 degrees to the axis of the holder so that the filter also has a tilt of 0.6 degrees to the holder while the filter is pasted on the carry surface.

8. A method for fixing optical element that is applied to construct the optical element in an wavelength division multiplexer (WDM) or an dense wavelength division multiplexer (DWDM), the method comprising:
providing a tubular holder with a hollow part, the holder having both of an incident end and an emitting end, and there is a carry surface between the incident end and the emitting end to paste a filter on the carry surface of the holder; and
installing the holder in a middle position of a mechanism body of the WDM or the DWDM.

9. The method according to claim 8, wherein the method further comprises the steps of installing a first collimator in one end of the mechanism body to let the first collimator face the filter surface of the holder, and installing a second collimator in the other end of the mechanism body.

10. The method according to claim 9, wherein the mechanism body has a containing space inside so as to contain the holder.

11. The method according to claim 10, wherein the containing space is machined a tilt angle of 0.6 degrees to the mechanism body so that the axis of the filter also has a tilt of 0.6 degrees to the axis of the mechanism body when the holder is installed into the containing space.

12. The method according to claim 10, wherein the normal of the carry surface has a tilt of 0.6 degrees to the axis of the holder so that the axis of the filter also has a tilt of 0.6 degrees to the axis of the mechanism body when the holder is installed into the containing space (the axis of the holder has a same direction with the axis of the mechanism body).

13. The method according to claim 10, wherein the size and shape of the containing space is made to suit the size and shape of the holder.

14. The method according to claim 8, wherein the appearance of the holder is a cuboid or a cube, and the shape of the carry surface is a circle.

15. The method according to claim 8, wherein the appearance of the holder is a cylinder and the shape of the carry surface is a circle.

16. The method according to claim 8, wherein the appearance of the mechanism body is a cuboid or a cube.

17. The method according to claim 8, wherein the appearance of the mechanism body is a cylinder.
